(19) United States
(12) Patent Application Publication
(10) Pub. No.: US 2012/0202399 A1
(43) Pub. Date: Aug. 9, 2012

(54) FOIL LAME' FABRICS AND METHODS OF MAKING FOIL LAME' FABRICS

(76) Inventors: Michael RUBIN, Colts Neck, NJ (US); Arnold Kobelt, Rye, NY (US)

(21) Appl. No.: 13/021,186

(22) Filed: Feb. 4, 2011

(51) Int. Cl. B32B 15/14; B44C 1/17; B32B 7/00; D02G 3/12; D03D 15/00

(52) U.S. Cl. 442/232; 57/235; 139/425 R; 156/241

(57) ABSTRACT

A new method for manufacturing a new foil lame′ fabric (1) accepts lame′ fabric that had been treated to accept binder, (2) applies binder to one side of the lame′ fabric, (3) arranges hot stamping foil on the side of the lame′ fabric to which binder had been applied, to define an arrangement (wherein the hot stamping foil includes a carrier), (4) hot presses the arrangement of hot stamping foil and lame′ fabric to create a foil-lame′ combination, (5) cures the foil-lame′ combination, and (6) removes the carrier from the foil-lame′ combination. The lame′ fabric accepted may be prepared by (1) treating a tinted polyester metalized film to accept a binder adapted to accept a clear hot melt adhesive to define a treated film, (2) slitting the treated film, (3) winding the slit, treated film onto bobbins, and (4) weaving the slit, treated film with nylon yarn to produce the lame′ fabric. The hot stamping foil may be prepared by (1) treating a clear polyester base film with a release coat, (2) tinting the treated clear polyester base film to a desired color, and (3) metalizing the treated and tinted clear polyester based film.

### §1. BACKGROUND OF THE INVENTION

§1.1 Field of the Invention

The present invention concerns processes for manufacturing fabrics and the fabrics produced. Specifically, the present invention concerns processes for manufacturing new foil lame′ fabrics, and the foil lame′ fabrics produced.

§1.2 Background Information

Tissue lame′ (also referred to simply as lame′) is a type of fabric woven or knit with thin “ribbons” (or “slits”) of metallic yarns, where the ribbons of metallic yarn are wrapped around a fiber yarn. Lame′ fabric is often gold or silver in color. Lame is often used in evening wear and dress wear, as well as in theatrical and dance costumes. Lame′ is appreciated as it drapes well. Unfortunately, however, an inherent defect with lame is that it is subject to seam or yarn slippage (referred to generally as “fraying”). This undesirable characteristic makes lame′ fabrics less than ideal for frequently used garments, for flags, for streamers, for banners, etc.

As can be appreciated from the foregoing, it would be useful to provide a lame′ fabric that does not fray. It would also be useful to provide a lame′ fabric that can have different colors on its two sides.

### §2. SUMMARY OF THE INVENTION

At least some embodiments consistent with the present invention provide a method for manufacturing a foil lame′ fabric by (1) accepting lame′ fabric that had been treated to accept binder, (2) applying binder to one side of the lame′ fabric, (3) arranging hot stamping foil on the side of the lame′ fabric to which binder had been applied, to define an arrangement, wherein the hot stamping foil includes a carrier, (4) hot pressing the arrangement of hot stamping foil and lame′ fabric to create a foil-lame′ combination, (5) curing the foil-lame′ combination, and (6) removing the carrier from the foil-lame′ combination.

In at least some embodiments consistent with the present invention, the lame′ fabric accepted may be prepared by (1) treating a tinted polyester metalized film to accept a binder adapted to accept a clear hot melt adhesive to define a treated film, (2) slitting the treated film, (3) winding the slit, treated film onto bobbins, and (4) weaving the slit, treated film with nylon yarn to produce the lame′ fabric.

Finally, in at least some embodiments consistent with the present invention, the hot stamping foil may be prepared by (1) treating a clear polyester base film with a release coat, (2) tinting the treated clear polyester base film to a desired color, and (3) metalizing the treated and tinted clear polyester based film.

### §3. BRIEF DESCRIPTION OF THE DRAWINGS

FIG. 1 illustrates an exemplary process for producing a foil-lame′ fabric in a manner consistent with the present invention.

FIG. 2 illustrates an exemplary process, consistent with the present invention, for preparing exemplary lame′ fabric used by the process of FIG. 1.

FIGS. 3A-3E illustrate examples of weaving patterns that may be used by the process of FIG. 2.

FIG. 4 illustrates an exemplary process, consistent with the present invention, for preparing exemplary hot stamping foil used in the process of FIG. 1

FIG. 5 illustrates a cross-section of an exemplary foil-lame′ fabric produced by the process of FIG. 1.

### §4. DETAILED DESCRIPTION

The present invention may involve novel fabrics and novel processes for manufacturing such novel fabrics. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventors regard their invention to include any patentable subject matter described.

§4.1 Manufacturing Foil-Lame′

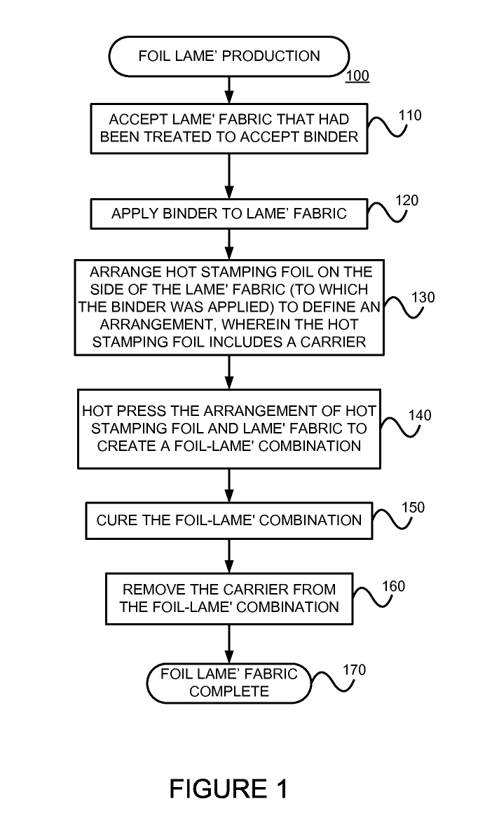

FIG. 1 illustrates an exemplary process 100 for producing a foil-lame′ fabric in a manner consistent with the present invention. A lame′ fabric that had been treated to accept binder is accepted. (Block 110). Binder (which is commonly referred to as “adhesive”) is applied to one side of the lame′ fabric. (Block 120) Hot stamping foil, which includes a carrier, is arranged on the side of the lame′ fabric to which the binder had been applied, to define an arrangement. (Block 130) The arrangement of hot stamping foil and lame′ fabric is then hot pressed to create a foil-lame′ combination. (Block 140) The foil-lame′ combination is then cured (Block 150) and the carrier is removed from the foil-lame′ combination (Block 160). The process for producing the foil-lame′ fabric now complete. (Node 170)

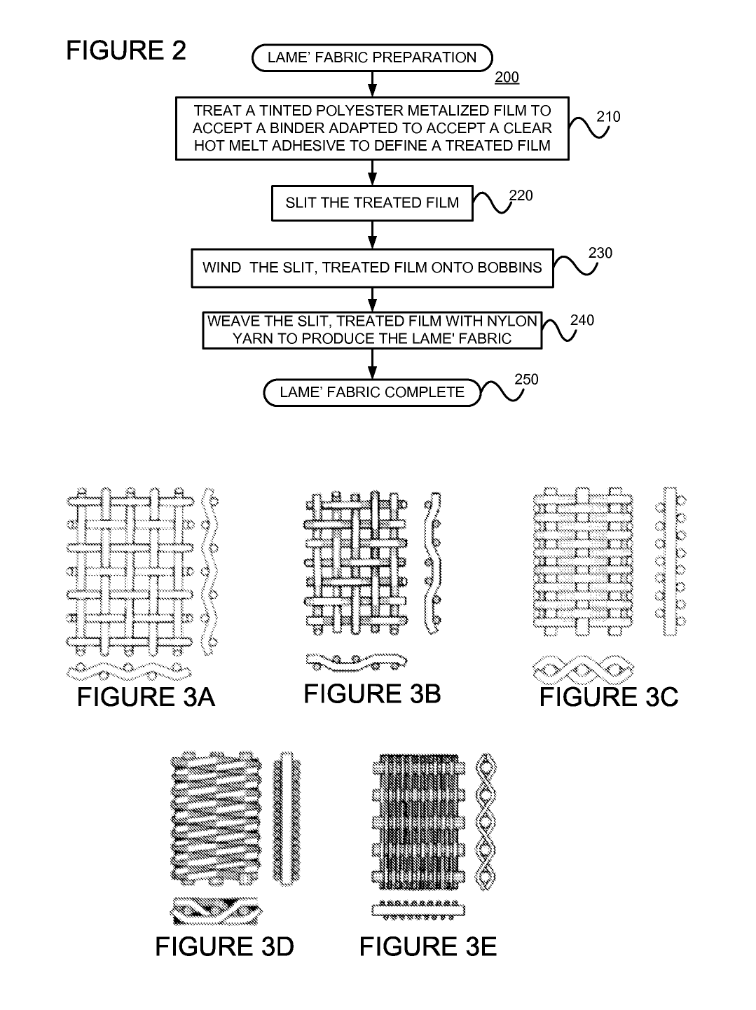

Referring back to block 110, in at least some embodiments consistent with the present invention, the lame′ fabric may have been produced as described in §4.1.1 below with reference to FIGS. 2-3E.

Referring back to block 120, in at least some embodiments consistent with the present invention, the binder should only be put on the side of the lame′ fabric that was previously treated prior to a yarn making process (described in §4.1.1 below). If applied to the other side, the desired adherence could be weakened.

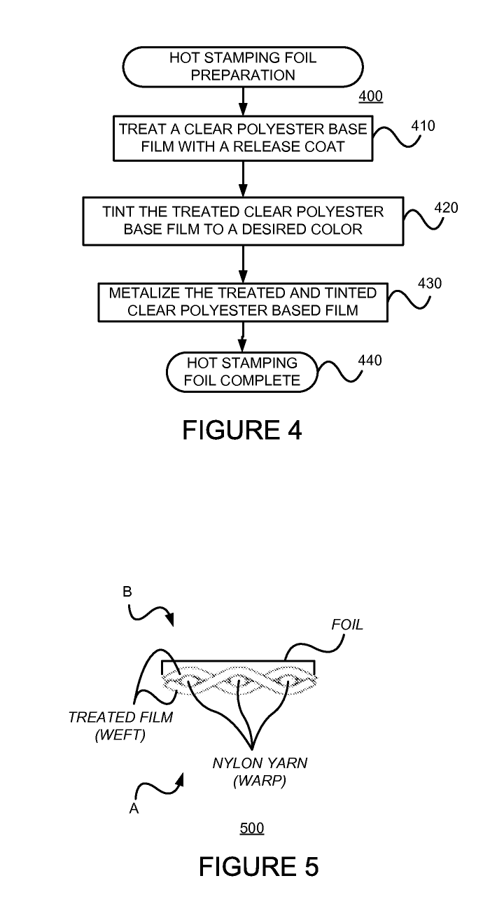

Referring back to block 130, in at least some embodiments consistent with the present invention, the hot stamping foil may have been produced as described in §4.1.2 below with reference to FIG. 4.

Referring back to block 140, in at least some embodiments consistent with the present invention, the lame′ fabric and the hot stamping foil are pressed together through a roller applying approximately 100 psi and 350° F. heat. This activates a hot melt adhesive (described below) and allows the foil to be transferred to the lame′ fabric. Other temperatures below 350° F., and other pressures, may be used, provided that the hot melt adhesive is activated, and the foil is transferred to the lame′ fabric. The fabric should move over the heat roller at a speed of at least one foot per second.

Referring back to block 150, in at least some embodiments consistent with the present invention, the foil lame′ combination is cured for approximately 72 hours before the user carrier is separated from the fabric. Increasing the cure time, for example to 168 hours, may advantageously provide better adherence.

Finally, referring back to block 160, in at least some embodiments consistent with the present invention, the carrier is separated from the fabric. In this case, the entire metallic surface of the foil is transferred to the lame′ fabric and a polyester carrier film remains. That is, when the carrier is separated, typically “all” of the foil will have been removed (from the carrier) and transferred to the fabric. However, in other embodiments, foil motifs are printed in the same manner and the carrier is removed with a reverse matrix. (This is different from the typical case in which, when separated, the carrier film has the reverse matrix of what was transferred to the fabric.) In some embodiments consistent with the present invention, after curing is complete, the used foil is pulled away and wound on a separate roller, while the fabric is rolled up into master rolls that may later be inspected and cut into 100 yard pieces.

The exemplary process 100 is advantageous because the treated face of the lame′ fabric, in combination with the adhesives, is used to get two metallic surfaces to adhere to each other. The resulting foil-lame′ remains strong and resists fraying and tearing, and is therefore suitable for uses including flags, streamers, decorations, banners, etc. Without the special preparations of the lame′ fabric, the metallic surface of the lame′ fabric would repel the metalized back side of the foil and the lame′ fabric and foil would not stick together.

§4.1.1 Manufacturing Treated Lame′ Fabric

FIG. 2 illustrates an exemplary process 200, consistent with the present invention, for preparing a lame′ fabric which may be used by the process 100 of FIG. 1. A tinted polyester metalized film is treated to accept a binder (which is adapted to accept a clear hot melt adhesive) to define a treated film. (Block 210) This chemical treatment “roughens” the surface of the otherwise very smooth and slick lame′ yarn. The treated film is then slit (e.g., into ribbons). (Block 220) The slit, treated film is then wound onto bobbins. (Block 230). Finally, the slit, treated film is woven with nylon yarn (Block 240) to complete production of the lame′ fabric (Block 250).

Referring back to block 210, the binder will later accept the clear hot melt adhesive during foil-lame′ production. (Recall FIG. 1.) In order to accept the binder, the tinted polyester metalized film may be treated as follows. A one-side coated carrier film that has sticky glue is run over the lame′, thereby transferring some of the adhesive from the carrier to the lame′ fabric. The combination of the chemical treatment to “roughen” the yarn, and the sticky glue transferred from the carrier film, prepares the surface properly for the foil transfer.

Referring back to block 220, in at least some embodiments consistent with the present invention, the tinted polyester metalized film may be slit into 1/69″ strips (or about 1/69″ strips). Slight variations to this strip width are possible, though too narrow a width may lack sufficient tensile strength for weaving, while too wide a width may become too rigid.

Referring back to block 240, in at least some embodiments consistent with the present invention, the slit, treated film (referred to as a “metallic yarn”) forms the weft of the lame′ fabric. In at least some of these embodiments, the warp is comprised of dyed nylon yarn, such as 30 Denier dyed nylon yarn for example. Polyester can be used instead of nylon. However, polyester is generally not used because it has to be dyed at higher temperatures. Nylon, on the other hand, can be dyed at lower temps and will not affect the metallic yarn. In some embodiments, 20 denier nylon can be used instead of 30 denier nylon.

Examples of weaving patterns that may be used are illustrated in FIGS. 3A-3E. FIG. 3C illustrates a desirable weave pattern. In at least some embodiments consistent with the present invention, the completed (woven) lame′ fabric consists essentially of 51% polyester metallic yarn and 49% 30 denier nylon. In some embodiments consistent with the present invention, the nylon yarn can be dyed to match the metallic yarn, while in other embodiments, it is left in its natural clear state. In at least some embodiments consistent with the present invention, the fabric is woven by conventional means to create a solid lame′ fabric (e.g., with front and back sides in the same color).

§4.1.2 Manufacturing Hot Stamping Foil

FIG. 4 illustrates an exemplary process 400, consistent with the present invention, for preparing hot stamping foil which may be used in the process 100 of FIG. 1. A clear polyester base film is treated with a release coat. (Block 410 The treated clear polyester base film is then tinted (if necessary) to a desired color. (Block 420) The treated and tinted clear polyester based film is then metalized. (Block 430) Finally, the treated, tinted and metalized clear polyester based film is then treated to produce the hot stamping foil.

Referring back to block 410, treating the clear polyester base film with a release coat will allow the foil to later be separated from the carrier and transferred to the lame′ fabric by means of a heat activated adhesive. (Recall the process 100 of FIG. 1.) The release coating is kind of like a wax coating that will allow the metalized foil to be pulled away smoothly from the clear poly film. The release coating is important to ensure a smooth transfer. If the coating is too hard, the adhesive might not extract the foil. If it's too soft, then the foil might off in flakes.

Referring back to block 420, the foil may be colored by a colored solution bathing the poly film and tinted when it is dried. However, the clear polyester base film need not be tinted. In such an embodiment, it would be a visible “clear foil” with the same texture as the metalized foil, but with no color and no metal. The foiled side would be shinier or wet looking as a result of the clear foil. The adhesive would be the same and would hold the metallic yarns in place in the same manner.

Referring back to block 430, metallization is commonly done for all hot stamping foils. For example, aluminum may be vaporized with high heat in a chamber where the tinted foil is placed. The vaporization aluminum contacts the poly film and condenses, giving the tinted color a metalized effect. However, the (e.g., tinted) polyester base film need not be metalized. The result would be a shiny, non-metalized “foil”. However, except for black and clear, non-metalized foils are not popular.

§4.2 Foil-Lame′ Article of Manufacture

FIG. 5 illustrates a cross-section of an exemplary foil-lame′ fabric 500 produced by the method 100 of FIG. 1. As shown, the final result of the method 100 is that the original lame′ (woven) fabric is exposed on one side (side A in FIG. 5) and the other side is coated with “allover” foil (side B in FIG. 5), thereby effectively creating a two-toned, reversible, lame′ fabric. The process 100 can be modified to add secondary designs to either side of the metallic fabric.

What is claimed is:

1. A method comprising:
a) accepting lame′ fabric that had been treated to accept binder;
b) applying binder to one side of the lame′ fabric;
c) arranging hot stamping foil on the side of the lame′ fabric to which binder had been applied, to define an arrangement, wherein the hot stamping foil includes a carrier;
e) hot pressing the arrangement of hot stamping foil and lame′ fabric to create a foil-lame′ combination;
e) curing the foil-lame′ combination; and
f) removing the carrier from the foil-lame′ combination.

2. The method of claim 1 wherein the lame′ fabric accepted is prepared by:
1) treating a tinted polyester metalized film to accept a binder adapted to accept a clear hot melt adhesive to define a treated film,
2) slitting the treated film,
3) winding the slit, treated film onto bobbins, and
4) weaving the slit, treated film with nylon yarn to produce the lame′ fabric.

3. The method of claim 2 wherein the treated film is slit into ribbons of about 1/69 of an inch.

4. The method of claim 2 wherein the nylon yarn is 20 or 30 Denier dyed nylon yarn.

5. The method of claim 2 wherein, in the woven lame′ fabric produced, the slit, treated film defines a weft of the weave and the nylon yarn defines a warp of the weave.

6. The method of claim 2 wherein the lame′ fabric produced consists essentially of approximately 51% of the slit, treated film and approximately 49% of the nylon yarn.

7. The method of claim 2 wherein the nylon yarn is dyed to match the slit, treated film.

8. The method of claim 2 wherein the lame′ fabric produced has a front side and back side in the same color.

9. The method of claim 1 wherein the hot stamping foil is prepared by:
1) treating a clear polyester base film with a release coat,
2) tinting the treated clear polyester base film to a desired color, and
3) metalizing the treated and tinted clear polyester based film.

10. The method of claim 1 wherein the act of hot pressing is performed at a temperature of 350 degrees Fahrenheit, or less.

11. The method of claim 1 wherein the act of hot pressing is performed at a pressure of 100 pounds per square inch.

12. The method of claim 1 wherein the act of curing the foil-lame′ combination takes between 72 and 168 hours.

13. An article of manufacture comprising:
a) a lame′ fabric; and
b) foil that has been hot-pressed onto the lame′ fabric.

14. The article of manufacture of claim 13 wherein a slit, treated and tinted polyester metalized film defines a weft of the lame′ fabric and a nylon yarn defines a warp of the lame′ fabric.

15. The article of manufacture of claim 14 wherein the lame′ fabric consist essentially of approximately 51% of the slit, treated and tinted polyester metalized film and approximately 49% of the nylon yarn.

16. The article of manufacture of claim 14 wherein the nylon yarn is 30 Denier dyed nylon yarn.

17. The article of manufacture of claim 14 included in a flag.

18. The article of manufacture of claim 14 included in a streamer.

19. The article of manufacture of claim 14 included in a banner.
